(19) United States
(12) Patent Application Publication
(10) Pub. No.: US 2011/0179462 A1
(43) Pub. Date: Jul. 21, 2011

(54) COMMUNICATION DEVICE, COMMUNICATION METHOD, RECORDING MEDIUM, AND INTEGRATED CIRCUIT

(76) Inventors: Seiji Kubo, Osaka (JP); Akihiro Ebina, Kyoto (JP); Kentaro Saito, Osaka (JP); Taku Matsuda, Nara (JP)

(21) Appl. No.: 13/021,257

(22) Filed: Feb. 4, 2011

Related U.S. Application Data
(63) Continuation of application No. PCT/JP2009/003704, filed on Aug. 4, 2009.

(30) Foreign Application Priority Data
Aug. 5, 2008 (JP) 2008-201522

(51) Int. Cl. H04N 7/173

(52) U.S. Cl. 725/110; 725/109

(57) ABSTRACT

A communication device includes: a wired communication unit configured to communicate with an external device via a wired communication path; a wireless communication unit configured to communicate with the external device via a wireless communication path; and a communication control unit configured to select one of the wired communication unit and the wireless communication unit, and to cause the selected communication unit to communicate with the external device. The communication control unit includes a link information detecting unit configured to detect link information indicating whether the wired communication path is electrically linked up or linked down, and the communication control unit is configured to select the wireless communication unit and cause the wireless communication unit to communicate with the external device when, in a state where the wired communication unit is selected, the link information detecting unit detects a plurality of times that the wired communication path is electrically linked down.

### CROSS REFERENCE TO RELATED APPLICATION

This is a continuation application of PCT application No. PCT/JP2009/003704, filed on Aug. 4, 2009, designating the United States of America.

### BACKGROUND OF THE INVENTION

(1) Field of the Invention

The present invention relates to communication devices, particularly to a communication device included in an audio-visual (AV) apparatus, such as a television (TV), having a network function.

(2) Description of the Related Art

In recent years, developments in communication networks have created an environment in which multimedia information, including images, is readily accessible at home and offices via the Internet through various distribution services, as represented by High Definition Television (HDTV) and the like.

In the meantime, there is a worldwide proliferation of wireless local area network (LAN) products compliant with IEEE 802.11a/b/g that is one of the wireless LAN standards. In addition, IEEE 802.11n, which is expected to enable even faster communication, is now under consideration. Communication with an AV apparatus such as a TV connected using a wireless LAN offers such convenience as eliminating the complication of routing the cable in the room and providing greater flexibility of where to place the apparatus. The communication using the wireless LAN, however, is not fast enough in some cases depending on the communication environment, and is not as stable as the communication using a wired LAN. Therefore, a communication device is hoped for which is connectable to a network by switching between the wired LAN and the wireless LAN depending on the situation.

Japanese Unexamined Patent Application Publication No. 2004-253974 (Patent Reference 1), for example, is known as the prior art of the invention of the present application.

### SUMMARY OF THE INVENTION

Patent Reference 1 discloses a switching apparatus which selects, when it is determined that a plurality of communication units included in a communication device is linked up, a communication unit having the highest throughput. However, this switching method has a problem that the communication unit is switched to another communication unit while a distribution service such as HDTV is being accessed, resulting in a disconnection of the communication which would have been continuable if such a switch did not take place.

This problem also occurs in a situation where the cable is momentarily plugged-out and then plugged-in during a wired communication, because in such a situation, a wireless link is selected even though the communication using the wired link is continuable, thereby causing a disconnection of the communication using the wired link. Particularly in the case of accessing a real-time distribution service using an AV apparatus such as a TV, there is a problem of a disconnection of a continuously-accessible service.

The present invention, conceived to solve the above problems, aims to provide a communication device capable of preventing a disconnection of communication which would normally be continuable, and capable of easily switching between a wired link and a wireless link.

A communication device according to an aspect of the present invention is a communication device which communicates with an external device. More specifically, the communication device includes: a wired communication unit configured to communicate with the external device via a wired communication path; a wireless communication unit configured to communicate with the external device via a wireless communication path; and a communication control unit configured to select one of the wired communication unit and the wireless communication unit, and to cause the selected communication unit to communicate with the external device. The communication control unit includes a link information detecting unit configured to detect link information indicating whether the wired communication path is electrically linked up or linked down, and the communication control unit is configured to select the wireless communication unit and cause the wireless communication unit to communicate with the external device when, in a state where the wired communication unit is selected, the link information detecting unit detects a plurality of times that the wired communication path is electrically linked down.

As in the above configuration, switching to the wireless communication unit when it is detected a plurality of times that the wired communication path is linked down makes it possible to prevent a disconnection of communication which would normally be continuable.

Each of the wired communication unit and the wireless communication unit is electrically connected with the communication control unit via a media independent interface (MII) bus which includes (i) a management data input-output/management data clock (MDIO/MDC) that transmits and receives a control signal and (ii) a data communication bus that transmits and receives data. The wired communication unit includes a register which holds the link information. The link information detecting unit may be configured to obtain the link information from the register of the wired communication unit via the MDIO/MDC. In addition, the communication control unit may be configured to select one of the wired communication unit and the wireless communication unit by electrically connecting the data communication bus with one of the wired communication unit and the wireless communication unit, and electrically disconnecting the data communication bus with the other one of the wired communication unit and the wireless communication unit.

As described above, in the case of using the MII bus, the communication control unit needs to exclusively select only one of the wired communication unit and the wireless communication unit. Application of the present invention to such a communication device produces a further advantageous effect. However, the communication bus between the communication control unit and the wired communication unit and between the communication control unit and the wireless communication unit is not limited to the MII bus; various other communication buses such as a peripheral component interconnect (PCI) bus, a universal serial bus (USB), and so on may be used

In addition, the communication control unit may be configured to put, in a high impedance state, at least an output terminal of the data communication bus for the unselected one of the wired communication unit and the wireless communication unit, so as to electrically disconnect the data communication bus. This enables exclusive selection of one of the wired communication unit and the wireless communication unit.

The communication device further includes a switch which is provided on the data communication bus and physically connects the communication control unit with only one of the wired communication unit and the wireless communication unit via the data communication bus. The communication control unit may be configured to select one of the wired communication unit and the wireless communication unit by switching the switch. This switch may be a mechanical switch or a semiconductor switch such as a switch transistor.

The communication control unit further includes a counter which counts the number of times the link information detecting unit detects that the wired communication path is electrically linked down. The communication control unit may be configured to cause the wireless communication unit to communicate with the external device when a value of the counter reaches a predetermined threshold. With this, detection that the wired communication path continues to be linked down allows switching to the wireless communication unit with appropriate timing.

In addition, the communication control unit may be configured to reset the counter with one of the following timing: timing with which the wireless communication unit is caused to communicate with the external device; timing with which the link information detecting unit detects that the wired communication path is electrically linked up; and timing with which a predetermined time period elapses after a last detection that the wired communication path is electrically linked down.

The communication control unit further includes a timer which starts with timing when the link information detecting unit detects that the wired communication path is electrically linked down. The communication control unit may be configured to cause the wireless communication unit to communicate with the external device when the link information detecting unit detects again, at a point in time when the timer expires, that the wired communication path is electrically linked down. With this, as in the case of using the counter, detection that the wired communication path continues to be linked down allows switching to the wireless communication unit with appropriate timing.

In addition, the communication control unit may be configured to cause the wired communication unit to communicate with the external device when, in a state where the wireless communication unit is selected, the link information detecting unit detects that the wired communication unit is electrically linked up and the wireless communication unit is not communicating with the external device. With this, it is possible to select a communication unit with more appropriate timing, for preventing a disconnection of communication which would normally be continuable.

A television receiver according to an aspect of the present invention is a television receiver connectable to a network. The television receiver includes: the communication device described above; and a display unit configured to display content obtained from the external device via the communication device.

A reproduction device according to an aspect of the present invention is a reproduction device connectable to a network. The reproduction device includes: the communication device described above; and a reproducing unit configured to reproduce content obtained from the external device via the communication device.

The present invention is widely applicable to, other than the television receiver and the reproduction device, a content processing device, such as a recording device, which obtains content via a network and processes (displays, reproduces, records, and so on) the content.

A communication method according to an aspect of the present invention is a communication method performed by a communication device to communicate with an external device. Here, the communication device includes: a wired communication unit configured to communicate with the external device via a wired communication path; and a wireless communication unit configured to communicate with the external device via a wireless communication path. More specifically, the communication method includes selecting one of the wired communication unit and the wireless communication unit, and causing the selected communication unit to communicate with the external device. The selecting includes detecting link information indicating whether the wired communication path is electrically linked up or linked down, and in the selecting, the wireless communication unit is selected and caused to communicate with the external device when it is detected a plurality of times in the detecting, in a state where the wired communication unit is selected, that the wired communication path is electrically linked down.

A recording medium according to an aspect of the present invention is a non-transitory computer-readable recording medium for use in a computer, the recording medium having a computer program recorded thereon for causing a communication device to communicate with an external device. Here, the communication device includes: a wired communication unit configured to communicate with the external device via a wired communication path; and a wireless communication unit configured to communicate with the external device via a wireless communication path. More specifically, the program causes the communication device to execute selecting one of the wired communication unit and the wireless communication unit, and causing the selected communication unit to communicate with the external device. The selecting includes detecting link information indicating whether the wired communication path is electrically linked up or linked down, and in the selecting, the wireless communication unit is selected and caused to communicate with the external device when it is detected a plurality of times in the detecting, in a state where the wired communication unit is selected, that the wired communication path is electrically linked down.

An integrated circuit according to an aspect of the present invention is an integrated circuit which communicates with an external device. More specifically, the integrated circuit includes: a wired communication unit configured to communicate with the external device via a wired communication path; a wireless communication unit configured to communicate with the external device via a wireless communication path; and a communication control unit configured to select one of the wired communication unit and the wireless communication unit, and to cause the selected communication unit to communicate with the external device. The communication control unit includes a link information detecting unit configured to detect link information indicating whether the wired communication path is electrically linked up or linked down, and the communication control unit is configured to select the wireless communication unit and cause the wireless communication unit to communicate with the external device when, in a state where the wired communication unit is selected, the link information detecting unit detects a plurality of times that the wired communication path is electrically linked down.

The communication control unit is configured to set, in the timer, a time until running out of a packet or data accumulated in at least one of a memory and a buffer by the communication device.

Note that the present invention can be realized not only as a communication device, but also as an integrated circuit implementing the functions of the communication device and a program causing a computer to execute such functions. It is apparent that such a program can be distributed via a recording medium such as a compact disc read-only memory (CD-ROM) and a transmission medium such as the Internet.

The above features make it possible to prevent a disconnection of communication which would normally be continuable, and to easily switch among a plurality of link units.

### FURTHER INFORMATION ABOUT TECHNICAL BACKGROUND TO THIS APPLICATION

The disclosure of Japanese Patent Application No. 2008-201522 filed on Aug. 5, 2008 including specification, drawings and claims is incorporated herein by reference in its entirety.

The disclosure of PCT application No. PCT/JP2009/003704, filed on Aug. 4, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1A is a schematic diagram of a television receiver including a communication device according to a first embodiment;

FIG. 1B is a schematic diagram illustrating a communication device according to the first embodiment;

FIG. 2 is a flowchart showing processing of a communication device according to the first embodiment when it is activated;

FIG. 3 is a flowchart showing an example of an operation performed by a communication device according to the first embodiment for switching from wired communication to wireless communication;

FIG. 4 is a schematic diagram illustrating a communication device according to a second embodiment;

FIG. 5 is a flowchart showing an example of an operation performed by a communication device according to the second embodiment for switching from wired communication to wireless communication;

FIG. 6 is a flowchart showing another example of an operation performed by a communication device according to the second embodiment for switching from wired communication to wireless communication;

FIG. 7 is a schematic diagram illustrating a communication device according to a third embodiment;

FIG. 8 is a flowchart showing an example of an operation performed by a communication device according to the third embodiment for switching from wired communication to wireless communication;

FIG. 9 is a flowchart showing an example of an operation performed by a communication device according to a fourth embodiment for switching from wireless communication to wired communication;

FIG. 10 is a flowchart showing another example of an operation performed by a communication device according to the fourth embodiment for switching from wireless communication to wired communication;

FIG. 11 is a flowchart showing yet another example of an operation performed by a communication device according to the fourth embodiment for switching from wireless communication to wired communication;

FIG. 12 is a schematic diagram illustrating a communication device according to a fifth embodiment;

FIG. 13 is a flowchart showing processing of a communication device according to the fifth embodiment when it is activated; and

FIG. 14 is a flowchart showing an example of an operation performed by a communication device according to the fifth embodiment for switching from wired communication to wireless communication.

### DESCRIPTION OF THE PREFERRED EMBODIMENT(S)

Hereinafter, specific embodiments of the present invention shall be described with reference to the drawings.

### First Embodiment

A first embodiment is based on an assumption of using, as the communication medium of a wired communication path, a wired LAN compliant with the IEEE 802.3 standard, and using, as the communication medium of a wireless communication path, a wireless LAN compliant with the IEEE 802.11 standard. Note that the communication standards used for the wired LAN and the wireless LAN are not limited to these, and any standard may be used as long as they are a communication standard for the communication medium of the wired communication path and a communication standard for the communication medium of the wireless communication path.

### Configuration of Communication Device According to First Embodiment

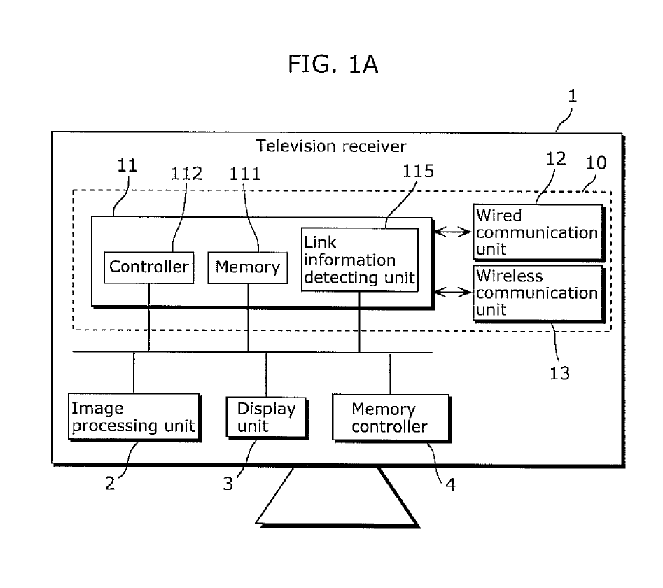

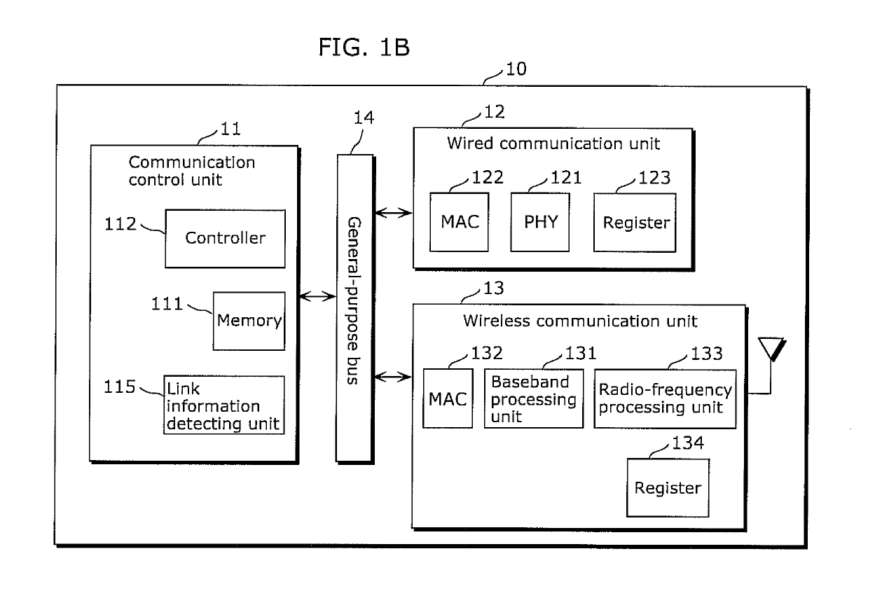

Hereinafter, a configuration of a communication device 10 according to the first embodiment of the present invention shall be described with reference to the drawings. Note that FIG. 1A is a schematic diagram of a television receiver (hereinafter referred to as “television”) 1 as an example of an AV apparatus including the communication device 10 according to the first embodiment. FIG. 1B is a schematic diagram illustrating the communication device 10 according to the first embodiment.

As shown in FIG. 1A, the television 1 according to the first embodiment of the present invention mainly includes a controller (also referred to as “central processing unit (CPU)”) 112, an image processing unit 2, a display unit 3, a memory controller 4, a memory 111, a link information detecting unit 115, a wired communication unit 12, and a wireless communication unit 13.

The controller 112 is connected to the image processing unit 2, the display unit 3, the memory controller 4, the memory 111, and the link information detecting unit 115 via a bus. The communication device 10 includes: the wired communication unit 12; the wireless communication unit 13; and a communication control unit 11 including the controller 112, the memory 111, and the link information detecting unit 115.

The image processing unit 2 decodes video data downloaded from broadcast waves or a network, and displays the decoded video data on the display unit 3. The display unit 3 displays video, and can be implemented by a cathode-ray tube, a liquid crystal display (LCD), a plasma display panel (PDP), an organic electro-luminescent (OEL) display, or the like. The memory controller 4 controls the interface of the memory 111, such as data reading and writing by the memory 111 and memory refresh in the case of a dynamic random access memory (DRAM).

The television 1 decodes, in the image processing unit 2, broadcast waves received by an antenna (not shown), and displays the decoded broadcast waves on the display unit 3. In addition, the television 1 selects one of the wired communication unit 12 and the wireless communication unit 13, and is connected to an external device (not shown) on the network via the selected communication unit. With this, it is also possible to decode, in the image processing unit 2, video data (content) obtained via the Internet and to display the decoded video data on the display unit 3, for example.

Note that although FIG. 1 shows an example of the television 1 including the communication device 10, the present invention is not limited to this, and can be applied to various content processing devices that process content obtained via a network. For example, the present invention may be applied to a reproduction device including a reproducing unit which reproduces content obtained from an external device via the communication device 10, or a recording device including a recording unit which records content obtained from an external device via the communication device 10. Note that various recording media may be used as the recording medium of the recording unit, such as a Blu-ray disk (BD), a digital versatile disk (DVD), a hard disk drive (HDD), and a nonvolatile memory.

As shown in FIG. 1B, the communication device 10 according to the first embodiment of the present invention includes the communication control unit 11, the wired communication unit 12, the wireless communication unit 13, and a general-purpose bus 14.

The communication control unit 11 communicates with the external device via the network using one of the wired communication unit 12 and the wireless communication unit 13. More specifically, the link information detecting unit 115 obtains, via the general-purpose bus 14, link information which indicates a link status between the wired communication unit 12 and the external device and is held by the wired communication unit 12, and link information which indicates a link status between the wireless communication unit 13 and the external device and is held by the wireless communication unit 13. The communication control unit 11 then performs control to select one of the wired communication unit 12 and the wireless communication unit 13 according to the link information obtained.

The memory 111 is a memory used when the communication control unit 11 performs the control. Any memory, such as a dynamic random access memory (DRAM), a synchronous dynamic random access memory (SDRAM), a flash memory, or a ferroelectric memory, may be used as the memory 111 as long as it can record data.

The controller 112 controls the operation of the communication device 10 as a whole by controlling the operations of the wired communication unit 12, the wireless communication unit 13, and the link information detecting unit 115. The controller 112 can be implemented by a semiconductor element or the like. In addition, the controller 112 may be configured only with hardware, or with a combination of hardware and software. The controller 112 can be implemented by a microcomputer.

According to the control by the controller 112, the link information detecting unit 115 obtains, via the general-purpose bus 14, information regarding a link (link information) held by a register 123 included in the wired communication unit 12. Likewise, the link information detecting unit 115 obtains, via the general-purpose bus 14, link information held by a register 134 included in the wireless communication unit 13. The link information detecting unit 115 may be configured only with hardware, or with a combination of hardware and software. Note that the “information regarding a link” is typically information which, in the case of a wired communication path, indicates whether the wired communication unit 12 is electrically linked up or linked down with the external device. On the other hand, in the case of a wireless communication path, it is information indicating whether a link is established between the wireless communication unit 13 and the external device (linked up) or not (linked down). Note that as for the wireless communication path, a link status with an access point, which is an external device, may be detected as information regarding a link of the communication device 10.

The wired communication unit 12 communicates with an external device on a communication network, using a wired LAN. The wired communication unit 12 includes, in a hierarchical structure of a communication protocol, a physical layer (PHY) 121 serving as the first layer of an OSI reference model, and a media access control (MAC) 122, and also includes the register 123.

Note that the register 123 holds, at least, the link information indicating whether the wired communication path between the wired communication unit 12 and the external device is linked up or linked down. The link information is written to the register 123 with the timing when the PHY 121 of the wired communication unit 12 detects that the wired communication path is “linked up” or “linked down”.

The wireless communication unit 13 communicates with the external device on the communication network, using a wireless LAN. The wireless communication unit 13 includes: a baseband processing unit 131 which performs baseband processing; an MAC 132; a radio-frequency processing unit 133 which performs radio-frequency processing; and the register 134. Note that as in the case of the wired communication unit 12, the register 134 holds, at least, the link information indicating whether or not the wireless communication path between the wireless communication unit 13 and the external device is linked up.

The general-purpose bus 14 is a communication path used for data transmission and receiving between the communication control unit 11, the wired communication unit 12, and the wireless communication unit 13. As the general-purpose bus 14, it is possible to use a PCI bus, a USB, a later-described media independent interface (MII) bus, or the like.

### Operation of Communication Device According to First Embodiment

Hereinafter, an operation of the communication device 10 according to the first embodiment of the present invention shall be described.

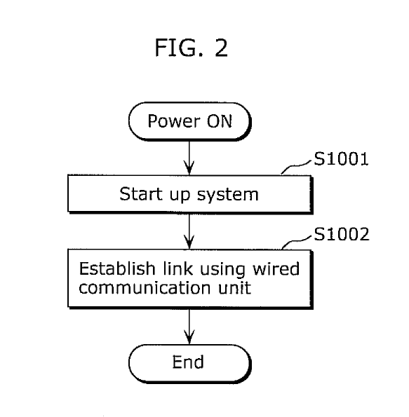

FIG. 2 is a flowchart showing an operation of the communication device 10 when it is powered on.

(Step S1001) First, the communication device 10, when powered on by a user or the like, starts up a system of the communication device 10 itself, and proceeds to Step S1002.

(Step S1002) Next, the controller 112 controls the wired communication unit 12 via the general-purpose bus 14 so that the wired communication unit 12 establishes a link with the external device via the wired LAN. Then, the controller 112 ends the processing.

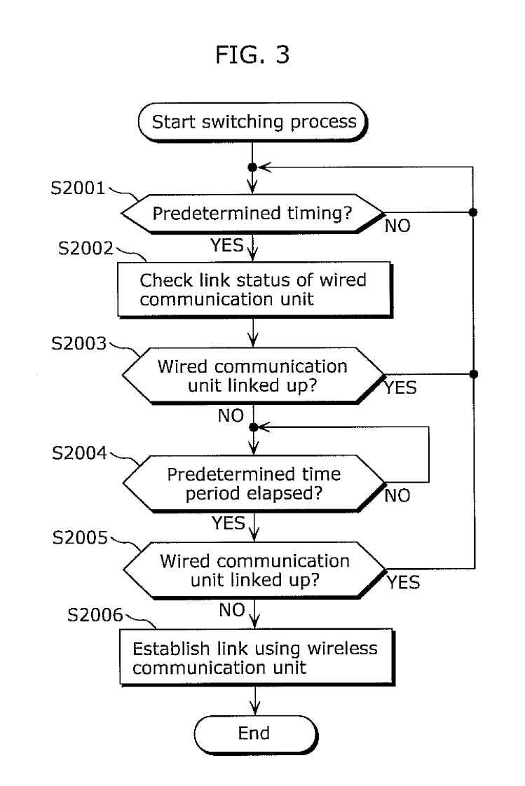

FIG. 3 is a flowchart showing an operation (switching from wired communication to wireless communication) performed by the communication device 10 according to the first embodiment when the communication device 10 is connected with the external device using the wired LAN.

(Step S2001) First, the controller 112 detects predetermined timing. In the case of detecting the predetermined timing (YES in Step S2001), the controller 112 proceeds to Step S2002. On the other hand, in the case of not detecting the predetermined timing (NO in Step S2001), the controller 112 returns to Step S2001.

(Step S2002) Next, the controller 112 causes the link information detecting unit 115 to obtain, via the general-purpose bus 14, the link information held by the register 123 of the wired communication unit 12, and proceeds to Step S2003.

(Step S2003) Based on the link information obtained in Step S2002, the controller 112 determines whether the wired communication unit 12 is electrically linked up or linked down. In the case of determining that the wired communication unit 12 is linked up (hereinafter, synonymous with “the wired communication path is linked up”) (YES in Step S2003), the controller 112 returns to Step S2001. On the other hand, in the case of determining that the wired communication unit 12 is linked down (NO in Step S2003), the controller 112 proceeds to Step S2004.

(Step S2004) Next, the controller 112 starts a timer. More specifically, the controller 112 measures a time starting from the determination in Step S2003 that the wired communication unit 12 is linked down, based on a system time clock (STC) of the communication device 10. When a predetermined time period has elapsed since the time measurement has started (YES in Step S2004), the controller 112 proceeds to Step S2005. On the other hand, when the predetermined time period has not elapsed (NO in Step S2004), the controller 112 continues to measure the time.

(Step S2005) Again, the controller 112 causes the link information detecting unit 115 to obtain, via the general-purpose bus 14, the link information held by the register 123 of the wired communication unit 12. Then, based on the obtained link information, the controller 112 determines the link status of the wired LAN. In the case of determining that the wired LAN is linked up (YES in Step S2005), the controller 112 returns to Step S2001. On the other hand, in the case of determining that the wired LAN is linked down (NO in Step S2005), the controller 112 proceeds to Step S2006.

(Step S2006) The controller 112 controls the wired communication unit 12 and the wireless communication unit 13 via the general-purpose bus 14 so that the wired communication unit 12 is disconnected and the wireless communication unit 13 is connected. The controller 112 then ends the operation. With this, the communication with the external device is performed via the wireless communication unit 13 from this time on.

The communication device 10 according to the first embodiment of the present invention having the above configuration performs data communication with another communication device. More specifically, the communication device 10 includes: the wired communication unit 12 that transmits and receives data to and from the other communication device via the wired network; the wireless communication unit 13 that transmits and receives data to and from the other communication device via the wireless network; the link information detecting unit 115 that detects the link information regarding a link between the other communication device and either the wired communication unit 12 or the wireless communication unit 13; and the communication control unit 11 that controls the communication of the wired communication unit 12 and the wireless communication unit 13.

Based on each piece of link information consecutively detected by the link information detecting unit 115, the communication control unit 11 consecutively determines a plurality of times the link status of the wired communication unit 12. Then, in the case of consecutively determining a plurality of times that the wired communication unit 12 is linked down, the communication control unit 11 is capable of controlling the wireless communication unit 13 so that the communication with the other communication device is performed using the wireless communication unit 13.

Therefore, even in the case where the wired communication unit 12 is momentarily linked down, the communication unit is not immediately switched to the wireless communication unit 13. This, as a result, produces an advantageous effect of allowing a continuation of the communication which would be disconnection in the case of the conventional method.

Note that the predetermined timing detected in Step S2001 may be a time point in each time cycle that is set and recorded in advance in the memory 111 or the like. In a specific implementation, the predetermined timing is set to two seconds, for example. In this case, the link information held by the register 123 can be checked at regular intervals, thereby making it possible to detect, in real time, whether or not the wired communication unit 12 is linked up with the external device.

In addition, the aforementioned time cycle may be changeable according to the load processed by the controller 112. This allows the communication device 10 to operate stably. Note that the predetermined timing is not limited to the value mentioned above, and is a value changeable to three, four, or five seconds, for example, according to the use status of the communication device according to an implementation of the present invention.

Furthermore, it is also possible to use the timing with which the communication control unit 11 obtains from the wired communication unit 12, as an interrupt to processing currently being executed by the communication control unit 11, a notification that the wired communication unit 12 is linked down. In this case, the register 123 is checked only when there is such an interrupt from the wired communication unit 12, thereby allowing reduction in the power consumption of the communication device 10.

Note that the predetermined time period in Step S2004 may be set in advance or set when the communication device 10 starts to be used. In addition, the predetermined time period may be changeable by the user or the like during the use of the communication device 10. With this, for example, in the case of the television 1 or the like which includes the communication device 10, it is possible to set the predetermined time period at the point in time when the wired communication unit 12 is linked down once, in consideration of a time until running out of a packet or data already accumulated in at least is one of a memory and a buffer by the communication device 10. This, as a result, enables switching between the communication units with the timing when the packet or data in at least one of the memory and the buffer runs out and video communication is discontinued.

Note that in Step S2004, in the case of checking, through an interrupt while waiting for a lapse of the predetermined time period, that the wired communication unit 12 is re-linked up, the controller 112 may return to Step S2001.

Note that in Step S2005, it has been explained that the controller 112 again causes the link information detecting unit 115 to obtain, via the general-purpose bus 14, the link information held by the register 123 of the wired communication unit 12, and determines the link status of the wired LAN based on the link information obtained. This operation may be replaced with an operation of checking, using an upper-layer application, whether or not a specified communication session is disconnection, and when it is checked that the communication session is disconnection, the controller 112 may proceed to Step S2006. In this case, whether or not to switch between the communication units can be determined after appropriately determining whether or not the communication can continue.

### Second Embodiment

The communication device 10 according to the first embodiment is configured in such a manner that when the controller 112 determines that the wired communication unit 12 is linked down with the external device, it is checked again, after a predetermined time period, whether or not the wired communication unit 12 is linked up with the external device. In a second embodiment, a communication device 20 is realized which: includes a link-down counter 117 which counts the number of times the wired communication unit 12 is linked down; and is capable of selecting one of the wired communication unit 12 and the wireless communication unit 13 according to the value of the link-down counter.

### Configuration of Communication Device According to Second Embodiment)

Hereinafter, the communication device 20 according to the second embodiment of the present invention shall be described with reference to the drawings.

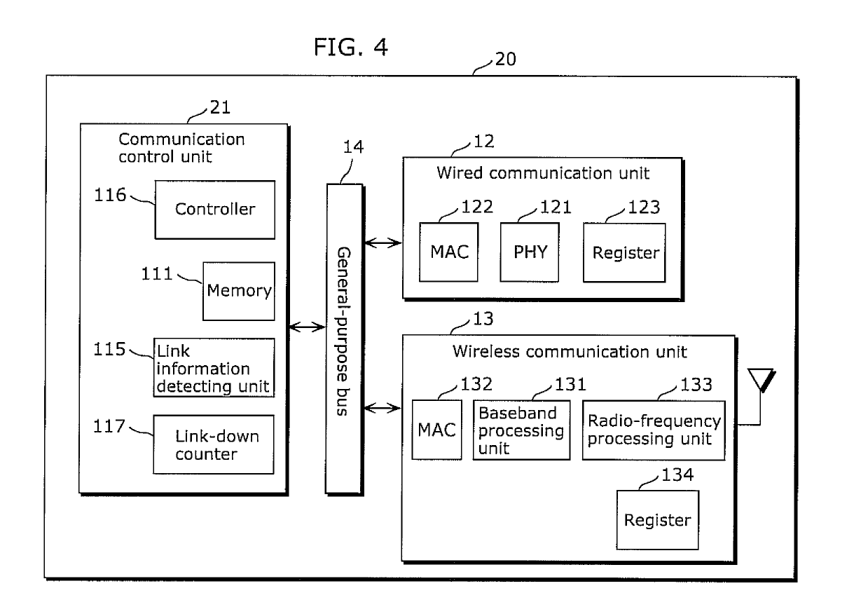

FIG. 4 is a schematic diagram illustrating the communication device 20 according to the second embodiment. Note that the constituent elements having the same configuration as those in the first embodiment are given the same reference numerals, and the descriptions thereof are not repeated.

In FIG. 4, the communication device 20 according to the second embodiment includes a communication control unit 21 in addition to the wired communication unit 12, the wireless communication unit 13, and the general-purpose bus 14 that are configured in the same manner as those in the first embodiment.

The communication control unit 21 includes a controller 116, the memory 111, the link information detecting unit 115, and the link-down counter 117.

The controller 116 controls the operation of the communication device 20 as a whole by controlling the operations of the wired communication unit 12, the wireless communication unit 13, the link information detecting unit 115, and the link-down counter 117. The controller 116 can be implemented by a semiconductor element or the like. In addition, the controller 116 may be configured only with hardware, or with a combination of hardware and software. The controller 116 can be implemented by a microcomputer.

The link-down counter 117 is controlled by the controller 116, and increments or decrements the value of a counter included in the link-down counter 117 when the controller 116 determines, upon checking the register 123 of the wired communication unit 12, that the wired communication unit 12 is linked down.

### Operation of Communication Device According to Second Embodiment)

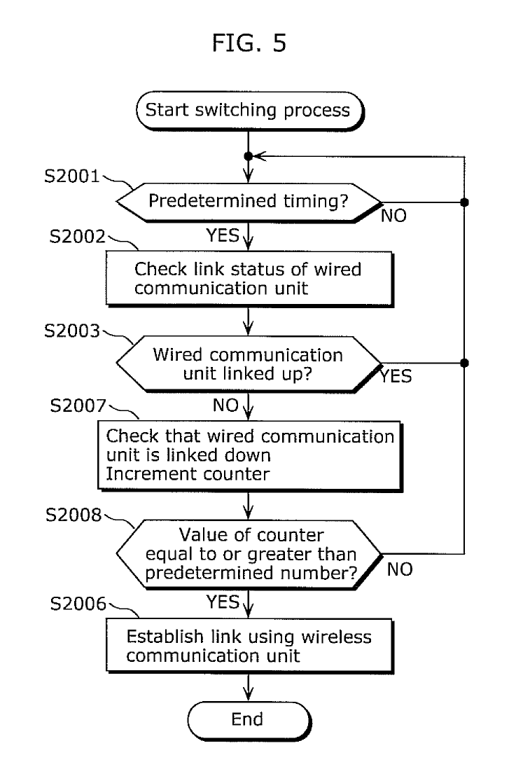

FIG. 5 is a flowchart showing an operation (switching from wired communication to wireless communication) performed by the communication device 20 according to the second embodiment when it is connected with the external device using the wired communication unit 12 included in the communication device 20.

Step S2001 and Step S2002 are the same as those in the first embodiment, and thus the descriptions thereof are not repeated. Note that the controller 112 is to be read as the controller 116.

(Step S2003) Based on the link information obtained in Step S2002, the controller 116 determines the link status of the wired communication unit 12. In the case of determining that the wired communication unit 12 is linked up (YES in Step S2003), the controller 116 returns to Step S2001. On the other hand, in the case of determining that the wired communication unit 12 is linked down (NO in Step S2003), the controller 116 proceeds to Step S2007.

(Step S2007) The controller 116 controls the link-down counter 117 so that the link-down counter 117 increments the value of the counter included in the link-down counter 117. The controller 116 then proceeds to Step S2008.

(Step S2008) The controller 116 checks the value of the counter included in the link-down counter 117, and proceeds to Step S2006 when the value of the counter is equal to or greater than a predetermined value (threshold) (YES in Step S2008). On the other hand, the controller 116 returns to Step S2001 when the value of the counter is smaller than the predetermined value (NO in Step S2008).

Step S2006 is the same as that in the first embodiment, and thus the description thereof is not repeated. Note that the controller 112 is to be read as the controller 116.

The communication device 20 according to the second embodiment of the present invention having the above configuration includes, in addition to the constituent elements of the communication device 10 in the first embodiment, the link-down counter 117 that counts the number of times of determination that the wired communication unit 12 is linked down. The communication control unit 21 increments the value of the link-down counter 117 when determining, based on the link information detected by the link information detecting unit 115, that the wired communication unit 12 is linked down. This makes it is possible for the communication control unit 21 to select and control the wireless communication unit 13 when the value of the link-down counter 117 reaches the threshold, so that the wireless communication unit 13 communicates with the external device.

Since the link status between the wired communication unit 12 and the external device is regularly checked, it is possible to immediately determine that the wired communication unit 12 is re-linked up.

Note that in the case where the link-down counter 117 decrements the counter value, the controller 116 may switch to the wireless communication unit 13 when the counter value of the link-down counter 117 is smaller than a predetermined value.

Note that the link-down counter 117 may be reset, for example, with one or both of the following timing: timing with which the wireless communication unit 13 is caused to communicate with the external device (Step S2006); and timing with which a predetermined time period elapses after a last detection that the wired communication path is electrically linked down.

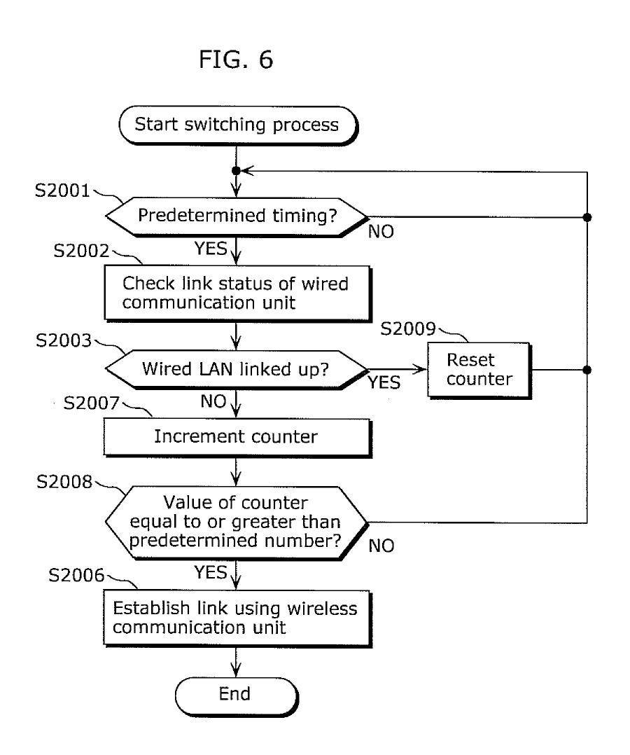

As shown in Step S2009 of FIG. 6, the value of the counter included in the link-down counter 117 may also be reset when it is determined that the wired communication unit 12 is linked up. Note that the controller 116 returns to Step S2001 after the value of the link-down counter 117 is reset.

As shown in FIG. 5, in the case of not resetting the link-down counter 117 with the timing of determining that the wired communication unit 12 is linked up (YES in Step S2003), it is possible to promptly switch to the wireless communication unit 13 in an unstable situation where the link information detecting unit 115 alternately detects the linked-up status and the linked-down status.

On the other hand, as shown in FIG. 6, in the case of resetting the link-down counter 117 (NO in Step S2009) with the timing of determining that the wired communication unit 12 is linked up (YES in Step S2003), it is possible to switch to the wireless communication unit 13 only when the communication status of the wired communication unit 12 is extremely unfavorable, such as when it is consecutively determined a plurality of times that the wired is communication unit 12 is linked down.

Note that in the case where the value of the counter included in the link-down counter 117 is smaller than a predetermined value, the predetermined timing detected in Step S2001 may be the timing with which the communication control unit 21 obtains from the wired communication unit 12, as an interrupt to processing currently being executed by the communication control unit 21, a notification that the wired communication unit 12 is linked down. On the other hand, in the case where the value of the counter of the link-down counter 117 is equal to or greater than the predetermined value, the predetermined timing detected in Step S2001 may be a time point in each time cycle recorded in advance in the memory 111. That is to say, the interrupt and the time cycle may be concurrently used for setting the predetermined timing. In this case, there is no need to check the register 123 when the value of the link-down counter 117 is smaller than the predetermined value, thereby allowing reduction in the power consumption of the communication device 10. In addition, the processing load of the controller 116 and so on can also be reduced.

### Third Embodiment

The communication device 10 according to a first embodiment is configured in such a manner that when the controller 112 determines that the wired communication unit 12 and the external device are linked down, it is checked again, after a predetermined time period, whether or not the wired communication unit 12 and the external device are linked up. In some cases, however, the user of the communication device 10 may wish to switch between the communication units through his direct operation. In view of such a circumstance, in the third embodiment, a communication device 30 is realized which: includes a communication selecting unit 15 through which the user can select one of the wired communication unit 12 and the wireless communication unit 13 as the communication unit that communicates with the external device; and is capable of selecting a communication unit according to the operation on the communication selecting unit 15.

### Configuration of Communication Device According to Third Embodiment

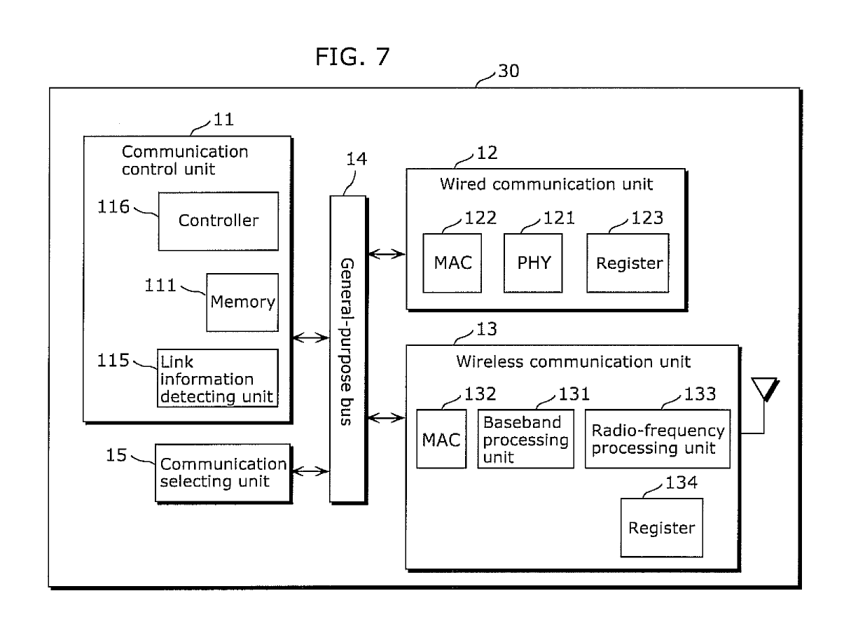

FIG. 7 is a schematic diagram illustrating the communication device 30 according to the third embodiment. Note that the constituent elements having the same configuration as those in the first embodiment are given the same reference numerals, and the descriptions thereof are not repeated.

In FIG. 7, the communication device 30 according to the third embodiment includes the communication selecting unit 15 in addition to the constituent elements of the communication device 10 in the first embodiment.

The communication selecting unit 15 is an operation unit operated by the user of the communication device 30. By operating the communication selecting unit 15, the user can select one of the wired communication unit 12 and the wireless communication unit 13 as the communication unit that communicates with the external device. When operated by the user, the communication selecting unit outputs an operating signal to the controller 116. The communication selecting unit 15 may be implemented, for example, by a button operable by being pressed by the user or a touch pad operable through a touch operation, or anything else as long as it allows the user to select one of the wired LAN and the wireless LAN.

### Operation of Communication Device According to Third Embodiment

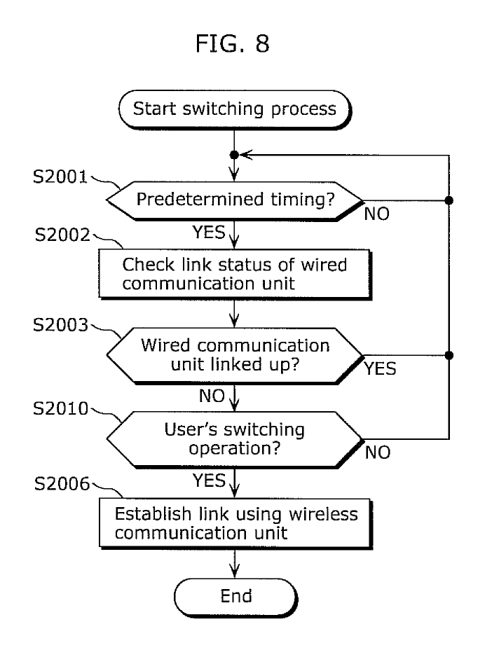

FIG. 8 is a flowchart showing an operation (switching from wired communication to wireless communication) performed by the communication device 30 according to the third embodiment when it is connected with the external device using the wired communication unit 12 included in the communication device 30.

Step S2001 and Step S2002 are the same as those in the first embodiment, and thus the descriptions thereof are not repeated. (Step S2003) Based on the link information obtained in Step S2002, the controller 116 determines the link status of the wired communication unit 12. In the case of determining that the wired communication unit 12 is linked up (YES in Step S2003), the controller 116 returns to Step S2001. On the other hand, in the case of determining that the wired communication unit 12 is linked down (NO in Step S2003), the controller 116 proceeds to Step S2010.

(Step S2010) The communication device 30 makes an inquiry, using the communication selecting unit 15, to the user about whether or not to switch from the wired communication unit 12 to the wireless communication unit 13. Then, the controller 116 determines whether or not an operating signal “switching allowed” has been input from the communication selecting unit 15. In the case where the operating signal “switching allowed” has been input (YES in Step S2010), the controller 116 proceeds to Step S2006. On the other hand, in the case where the operating signal “switching allowed” has not been input or an operating signal “switching not allowed” has been input (NO in Step S2010), the controller 116 returns to Step S2001.

Step S2006 is the same as that in the first embodiment, and thus the description thereof is not repeated.

The communication device 30 according to the third embodiment of the present invention having the above configuration includes the communication selecting unit 15 through which the user selects one of the wired communication unit and the wireless communication unit as the communication unit that communicates with the external device. More specifically, in the case where an operation for allowing the switching to the wireless communication unit 13 is detected from the communication selecting unit 15 after it is determined based on the link information detected by the link information detecting unit 115 that the wired communication unit 12 is linked down, it is possible to perform control to switch the communication unit used in the communication device 30 to the wireless communication unit 13.

Therefore, the communication unit that communicates with the external device can be changed to one of the wired communication unit 12 and the wireless communication unit 13 in response to the user's request.

Note that when the processing proceeds from Step S2003 to Step S2010, it is possible to prompt the user to operate the communication selecting unit 15 by displaying a message “Switch from wired communication to wireless communication?” or the like on the display unit 3 of the television 1. In this case, the user can be prompted, with appropriate timing, to determine whether or not to switch between the communication units.

Note that the controller 116 in Step S2010 may proceed to Step S2006 when no operating signal is output from the communication selecting unit 15 within a predetermined time period. In this case, the switching processing can proceed smoothly.

### Fourth Embodiment

The communication devices in the first through third embodiments are configured to switch from the wired LAN to the wireless LAN. In a fourth embodiment, the communication device is configured to switch from the wireless LAN to the wired LAN.

### Configuration of Communication Device According to Fourth Embodiment

The configuration of a communication device 10 according to the fourth embodiment of the present invention is the same as that of the communication device 10 according to the first embodiment, and thus the description thereof is not repeated.

### Operation of Communication Device According to Fourth Embodiment

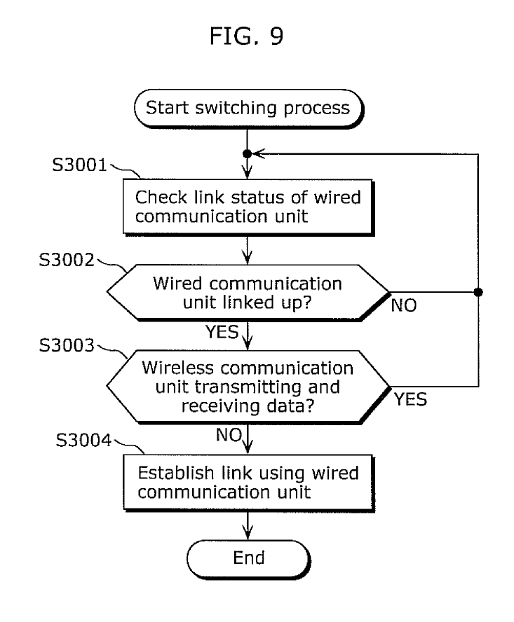

FIG. 9 is a flowchart showing an operation (switching from wireless communication to wired communication) performed by the communication device 10 according to the fourth embodiment when it is communicating with the external device using the wireless communication unit 13. Note that the following describes processing performed when the wired communication unit 12 is linked down and the wireless communication unit 13 is linked up. However, the processing below can also be applied to processing performed when both the wired communication unit 12 and the wireless communication unit 13 are linked down, that is, when the communication device 10 is not communicating with the external device.

(Step S3001) First, when only the wireless communication unit 13 of the communication device 10 is linked up, the controller 112 causes the link information detecting unit 115 to obtain, via the general-purpose bus 14, the link information held by the register 123 of the wired communication unit 12, and proceeds to Step S3002.

(Step S3002) Next, the controller 112 determines the link status of the wired communication unit 12 based on the link information obtained in Step S3001. In the case of determining that the wired communication unit 12 is linked down (NO in Step S3002), the controller 112 returns to Step S3001. On the other hand, in the case of determining that the wired communication unit 12 is linked up (YES in Step S3002), the controller 112 proceeds to Step S3003.

(Step S3003) The controller 112 determines whether or not the wireless communication unit 13 is transmitting and receiving data to and from the external device. When the data transmission and receiving is being performed (YES in Step S3003), the controller 112 returns to Step S3001. On the other hand, when the data transmission and receiving is not being performed (NO in Step S3003), the controller 112 proceeds to Step S3004.

(Step S3004) The controller 112 controls the wireless communication unit 13 and the wired communication unit 12 via the general-purpose bus 14 so that the wireless communication unit 13 is disconnected and the wired communication unit 12 is connected. The controller 112 then ends the operation.

The communication device 10 according to the fourth embodiment of the present invention having the above configuration includes: the wired communication unit 12 that transmits and receives data to and from the external device via the wired network; the wireless communication unit 13 that transmits and receives data to and from the external device via the wireless network; the link information detecting unit 115 that detects the link information of either the wired communication unit 12 or the wireless communication unit 13; and the communication control unit 11 that is connected with the wired communication unit 12 and the wireless communication unit 13 via the general-purpose bus 14 and controls the communication of the wired communication unit 12 and the wireless communication unit 13.

In the case of determining, based on the link information detected by the link information detecting unit 115, that the wired communication unit 12 is linked up, the communication control unit 11 selects the wired communication unit 12 and performs control so that the communication with the external device is performed using the wired communication unit 12.

As a result, the communication unit can be switched to the wired communication unit 12 anytime to enable the communication, as long as a link can be established with the external device using the wired communication unit 12.

Note that the determination as to whether or not the wireless communication unit 13 is transmitting and receiving data to and from the external device can be performed by: determining whether or not the communication session is disconnection; checking the link status between the wireless communication unit 13 and the external device; or other methods, in addition to the method of checking whether or not data is actually being transmitted and received.

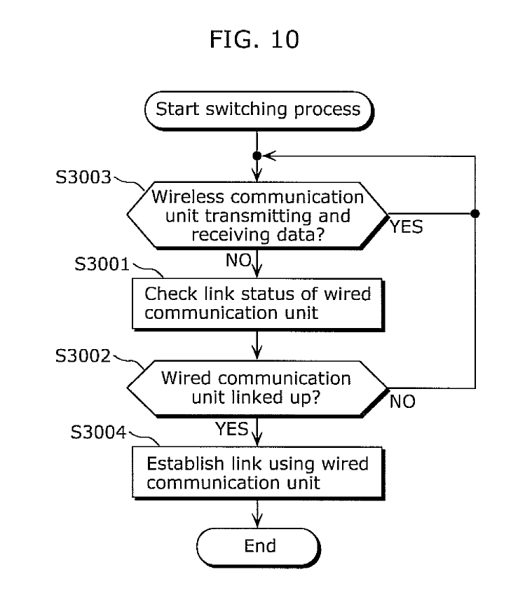

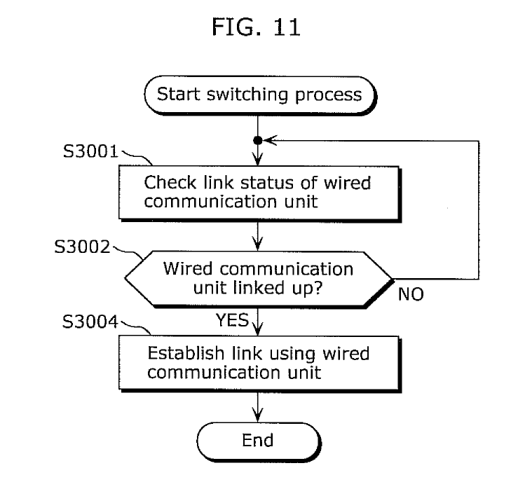

Note also that the determination in Step S3003 as to whether or not the wireless communication unit 13 is transmitting and receiving data to and from the external device is not limited to the above processing order, and may be performed prior to Step S3001 as shown in FIG. 10. In addition, depending on the priority of the data being transmitted and received, this determination may be omitted. Moreover, in the case of giving a higher priority to the communication using the wired communication unit 12, this determination may be completely omitted as shown in FIG. 11.

Furthermore, with the communication device 10 which performs real-time data transmission and receiving as in the case of a TV, for example, it is important to keep enough transmission rate for real-time data. Therefore, the above determination may be performed based on an assumption that a PHY rate below a certain level in the wireless period indicates that the data transmission and receiving is not being performed.

With an apparatus which includes a display unit such as a TV, the display unit may display a screen that prompts the user to select one of the wired communication unit 12 and the wireless communication unit 13, instead of the determination as to whether or not the wireless communication unit 13 is transmitting and receiving data to and from the external device. In this case, the user can be prompted, with appropriate timing, to determine whether or not to switch between the communication units.

Note that the check of the link status of the wired communication unit 12 in Step S3001 may be performed using the time cycle recorded in advance in the memory 111. In this case, the link status of the wired LAN can be checked at regular intervals, thereby making it possible to detect, in real time, whether or not the wired communication unit 12 is linked up. Furthermore, the aforementioned time cycle may be changeable according to the use status of the controller 112. This allows the communication device 10 to operate stably. Moreover, it is also possible to use the timing with which the communication control unit 11 obtains from the wired communication unit 12, as an interrupt to processing currently being executed by the communication control unit 11, a notification that the wired communication unit 12 is linked down. In this case, the register 123 is checked only when there is such an interrupt from the wired communication unit 12, thereby allowing reduction in the power consumption of the communication device 10. In addition, the processing load of the CPU and so on can also be reduced.

### Fifth Embodiment

The first through fourth embodiments have been illustrated as embodiments of the present invention. However, embodiments of the present invention are not limited to these embodiments, and a media independent interface (MII) bus may be used as the general-purpose bus 14. The MII bus includes: a management data input-output/management data clock (MDIO/MDC) 17a which transmits and receives a control signal; and a data communication bus 17b which transmits and receives data.

The data communication bus 17b is a communication path used for data transmission and receiving between the communication control unit 41 and the wired communication unit 42 and between the communication control unit 41 and the wireless communication unit 43, and includes the following data lines compliant with the IEEE 802.3 standard: TX_ER, TX_EN, TXD0-3, and TX_CLK for transmission; RXD0-3, RX_DV, RX_CLK, and RX_ER for receiving ; and COL and CRS of a half-duplex control system. However, not all of these data lines are necessary. For example, COL and CRS, which are data lines for half-duplex control, are unnecessary in the case of not performing half-duplex communication.

The MDIO/MDC 17a is a signal line for passing signals of a management data input-output (MDIO) and a management data clock (MDC) compliant with the IEEE 802.3 standard, and is a signal line that allows the communication control unit 41, which is the control host, and the wired communication unit 42 and the wireless communication unit 43, which are the control slaves, to exchange information in accordance with a management frame format.

Note that the data communication bus 17b of the MII bus, which is the signal line for data transmission and receiving, cannot be concurrently connected with the wired communication unit 42 and the wireless communication unit 43 electrically. Thus, a communication device 40 according to a fifth embodiment controls a switch 16 using a communication control unit 41, and exclusively switches between the electrical connection of the wired communication unit 42 with the communication control unit 41 and the electrical connection of the wireless communication unit 43 with the communication control unit 41, so as to perform one of the wired communication and the wireless communication.

### Configuration of Communication Device According to Fifth Embodiment

Hereinafter, a configuration of the communication device 40 according to the fifth embodiment of the present invention shall be described with reference to the drawings.

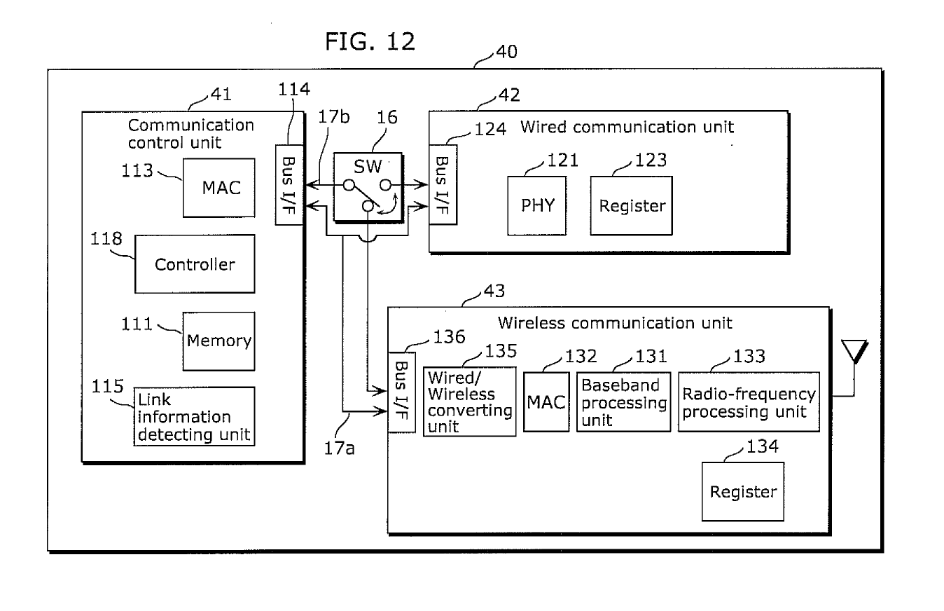

FIG. 12 is a schematic diagram illustrating the communication device 40 according to the fifth embodiment.

The communication device 40 according to the fifth embodiment of the present invention includes the communication control unit 41, a wired communication unit 42, a wireless communication unit 43, the MDIO/MDC 17a, the data communication bus 17b, and the switch 16. Note that the constituent elements having the same configuration as those in the first to fourth embodiments are given the same reference numerals, and the descriptions thereof are not repeated.

The communication control unit 41 includes an MAC 113, a controller 118, a bus interface (IF) 114, the memory 111, and the link information detecting unit 115. The communication control unit 41 obtains the link information which indicates a link status between the wired communication unit 42 and the external device and is held by the wired communication unit 42, and the link information which indicates a link status between the wireless communication unit 43 and the external device and is held by the wireless communication unit 43. The communication control unit 41 performs control to select a communication unit according to the link information obtained. The communication control unit 41 also controls the switch 16 so that unselected communication unit is electrically disconnected with the selected communication unit and the communication control unit 41. The communication control unit 41 communicates with the external device via the network using one of the wired communication unit 42 and the wireless communication unit 43.

The bus IF 114 is a bus IF connectable to at least the data communication bus 17b among the signal buses of the MII bus.

The MAC 113 is an MAC which handles a frame compliant with the IEEE 802.3 standard.

The wired communication unit 42 includes the PHY 121, the register 123, and a bus IF 124. The bus IF 124 is a bus IF connectable to at least the data communication bus 17b among the signal buses of the MII bus.

The wireless communication unit 43 includes the baseband processing unit 131, the MAC 132, the radio-frequency processing unit 133, the register 134, a bus IF 136, and a wired/wireless converting unit 135.

The bus IF 136 is a bus IF connectable to at least the data communication bus 17b among the signal buses of the MII bus.

The wired/wireless converting unit 135 is a converting unit which converts a frame compliant with the IEEE 802.3 standard into a frame compliant with the IEEE 802.11 standard, and vice versa. Note that the standard of the frame after conversion is not limited to the IEEE 802.11 standard, and may be any standard as long as it is a communication standard allowing processing by the wireless communication unit 43.

The switch 16 switches, for the data communication bus 17b, between the electrical (physical) connection and disconnection of the communication control unit 41 with the communication units according to the control by the communication control unit 41. More specifically, the switch 16 connects one of the wired communication unit 42 and the wireless communication unit 43 with the communication control unit 41, and disconnects the other one with the communication control unit 41. Note that the switch 16 may be a switch that mechanically switches between the connection targets, or a semiconductor switch such as a switch transistor.

Note also that the switching function of the switch 16 may be provided in the bus IF 124 and the bus IF 136. In this case, any method such as the following method may be used as long as the wired communication unit 42 and the wireless communication unit 43 can be connected electrically independently of each other. That is, it is possible to use a method in which, for example, when the communication control unit 41 and one of the communication units are to be electrically disconnection, data-communication-related output terminals of the bus IFs included in the wired communication unit 42 and the wireless communication unit 43 (RXD0-3, RX_DV, RX_CLK, RX_ER, TX_ER, and TX_CLK) are put in a high impedance state and the input terminals (TX_EN and TXD0-3) are caused to ignore input data. Note that the output terminals and the input terminals are not limited to those listed above, and TX_CLK and RX_CLK may serve as the input terminals, for example.

### Operation of Communication Device According to Fifth Embodiment

Hereinafter, an operation of the communication device 40 according to the fifth embodiment of the present invention shall be described. Note that the following definitions are assumed in the fifth embodiment: Status A is a status in which the wired communication unit 42 is electrically connected with the communication control unit 41, and the wireless communication unit 43 is electrically disconnected with the communication control unit 41, whereas Status B is a status in which the wired communication unit 42 is electrically disconnected with the communication control unit 41, and the wireless communication unit 43 is electrically connected with the communication control unit 41.

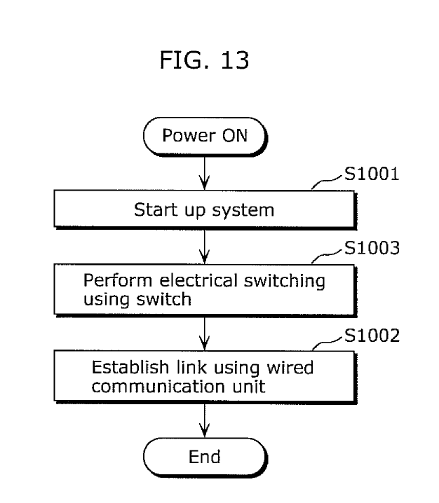

FIG. 13 is a flowchart showing an operation of the communication device 40 according to the fifth embodiment when it is powered on.

(Step S1001) First, the communication device 40, when powered on by the user or the like, starts up a system of the communication device 40 itself, and proceeds to Step S1003.

(Step S1003) Next, the controller 118 controls the switch 16 so that the switch 16 performs switching to bring about Status A. The controller 118 then proceeds to Step S1002.

(Step S1002) Next, the controller 118 controls the wired communication unit 42 via the data communication bus 17b so that the wired communication unit 42 starts communication with the external device via the wired LAN. The controller 118 then ends the operation.

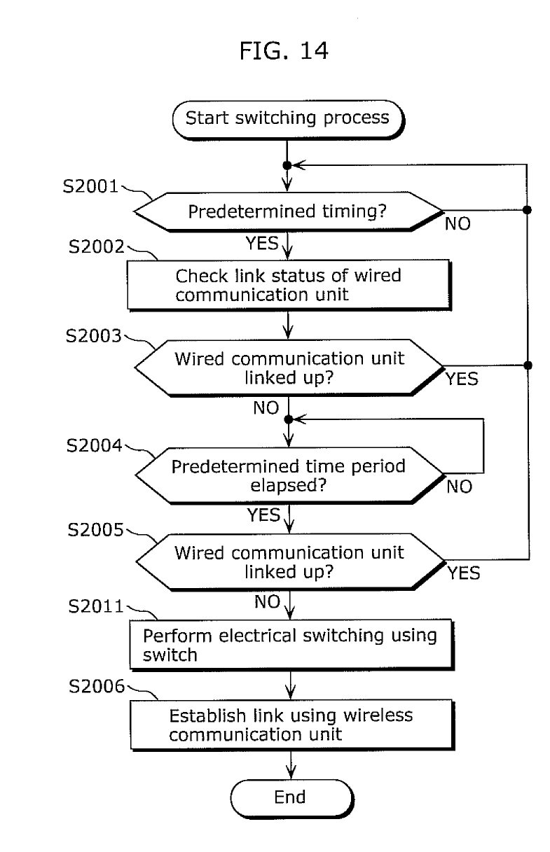

FIG. 14 is a flowchart showing an operation (switching from wired communication to wireless communication) performed by the communication device 40 according to the fifth embodiment when it is connected with the external device using the wired communication unit 42 included in the communication device 40.

Steps S2001 to S2005 are the same as those in the first embodiment, and thus the descriptions thereof are not repeated. Note that the controller 112 is to be read as the controller 118.

(Step S2011) Next, the controller 118 controls the switch 16 so that the switch 16 performs switching to bring about Status B. The controller 118 then proceeds to Step S2006.

(Step S2006) The controller 118 controls the wireless communication unit 43 so that the wireless communication unit 43 communicates with the external device. The controller 118 then ends the operation.

The communication device 40 according to the fifth embodiment of the present invention having the above configuration is capable of switching the switch 16 according to the link status of each communication unit, and is thus capable of performing the same operation as that in the first embodiment even in the case where the communication control unit 41 and one of the wired communication unit 42 and the wireless communication unit 43 are electrically connected using the MII bus.

This enables the conventional communication device, capable of performing only the communication using the wired LAN, to use the wired LAN and the wireless LAN while switching between them, without a change in the physical configurations of the communication control unit 41 and the wired communication unit 42. Furthermore, even in the case of performing the wireless communication, the communication control unit 41 and the wireless communication unit 43 transmit and receive frames compliant with the IEEE 802.3 standard. Therefore, the communication control unit 41 can use, without making any changes, hardware and software which are for used for the communication via the wired LAN. In addition, the processing load of the communication control unit 41 can be reduced as compared to the case where the communication control unit 11 performs the communication via the wireless LAN using the PCI bus as the general-purpose bus.

Note that the check of the link status performed by the controller 118 is not limited to the check as described above. For example, the communication control unit 41 may check the link status of the wired communication unit 42 using the MDIO/MDC compliant with the IEEE 802.3 standard, or the check may be performed using another communication unit, such as a communication unit used for serial communication.

Note that although the fifth embodiment has illustrated the configuration in which the media independent interface (MII) bus is used as the general-purpose bus 14, it is also possible to use, as a replacement for the MII serving as the general-purpose bus 14, a reduced media independent interface (RMII) intended to reduce the number of MII pins, a gigabit media independent interface (GMII) capable of processing at a speed of 1G bit/second, or a reduced gigabit media independent interface (RGMII) intended to reduce the number of GMII pins.

### Other Embodiments

Note that the communication devices according to the first through fourth embodiments are capable of performing the same operations even in the case of using the MII bus as the general-purpose bus, by utilizing the configuration according to the fifth embodiment.

Note that although the first through fifth embodiments of the present invention have illustrated the communication devices including the wired communication unit and the wireless communication unit, these communication units are not limited to wired or wireless communication units, and the communication devices may include a plurality of communication units that use power line communications (PLC), C.Link, or the like.

Note that although the present invention has been described based on the above embodiments, it is apparent that the present invention is not limited to such embodiments. The present invention also includes such cases as below.

Each of the devices described above is specifically a computer system including a microprocessor, a read-only memory (ROM), a random-access memory (RAM), a hard disk unit, a display unit, a keyboard, a mouse, and so on. A computer program is stored in the RAM or the hard disk unit. The respective devices achieve their functions through the microprocessor's operation according to the computer program. Here, the computer program is a combination of a plurality of instruction codes indicating instructions for the computer, so that a predetermined function is achieved.

Some or all of the constituent elements of the respective devices may be configured from a single system large-scale integrated (LSI) circuit. The system LSI is a super-multifunction LSI manufactured by integrating a plurality of constituent elements on a single chip, and is specifically a computer system including a microprocessor, a ROM, a RAM, and so on. A computer program is stored in the RAM. The system LSI achieves its function through the microprocessor's operation according to the computer program.

Some or all of the constituent elements of the respective devices may be configured as an integrated circuit (IC) card attachable to the respective devices or as a stand-alone module. The IC card or the module is a computer system including a microprocessor, a ROM, a RAM, and so on. The IC card or the module may include the aforementioned super-multifunction LSI. The IC card or the module achieves its function through the microprocessor's operation according to the computer program. The IC card or the module may be tamper-resistant.

The present invention may be realized as the methods described above. In addition, the present invention may be a computer program for executing such methods using a computer, and may also be a digital signal including the computer program.

Moreover, the present invention may also be realized by storing the computer program or the digital signal in a computer-readable recording medium such as a flexible disc, a hard disk, a CD-ROM, a magneto-optical (MO) disk, a digital versatile disc (DVD), a digital versatile disc read-only memory (DVD-ROM), a digital versatile disc random-access memory (DVD-RAM), a Blu-ray disc (BD), and a semiconductor memory. Furthermore, the present invention may also be realized as the digital signal recorded on these recording media.

In addition, the present invention may also be realized by transmission of the computer program or the digital signal via a telecommunication line, a wireless or wired communication line, a network represented by the Internet, a data broadcast, and so on.

Moreover, the present invention may also be realized as a computer system including a microprocessor and a memory, in which the memory stores the computer program and the microprocessor operates according to the computer program.

Furthermore, by transferring the program or the digital signal recorded on the recording media, or by transferring the program or the digital signal via the network and the like, implementation using another independent computer system is also possible.

It is also possible to combine the above embodiments and variations.

Although only some exemplary embodiments of this invention have been described in detail above with reference to the drawings, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

A communication-unit switching apparatus and the switching method according to the present invention for using a wired link unit and a wireless link unit while switching between them are mainly used in AV apparatuses, such as TVs, which include a wired link unit and a wireless link unit. However, they are also applicable to AV apparatuses which include at least two link units which are not limited to a combination of a wired link unit and a wireless link unit. In addition, the switching method is applicable not only to AV apparatuses but also to communication devices in general that include a plurality of communication units.

What is claimed is:

1. A communication device which communicates with an external device, said communication device comprising:
a wired communication unit configured to communicate with the external device via a wired communication path;
a wireless communication unit configured to communicate with the external device via a wireless communication path; and
a communication control unit configured to select one of said wired communication unit and said wireless communication unit, and to cause said selected communication unit to communicate with the external device,
wherein said communication control unit includes
a link information detecting unit configured to detect link information indicating whether the wired communication path is electrically linked up or linked down, and
said communication control unit is configured to select said wireless communication unit and cause said wireless communication unit to communicate with the external device when, in a state where said wired communication unit is selected, said link information detecting unit detects a plurality of times that the wired communication path is electrically linked down.

2. The communication device according to claim 1,
wherein each of said wired communication unit and said wireless communication unit is electrically connected with said communication control unit via a media independent interface (MII) bus which includes (i) a management data input-output/management data clock (MDIO/MDC) that transmits and receives a control signal and (ii) a data communication bus that transmits and receives data,
said wired communication unit includes a register which holds the link information,
said link information detecting unit is configured to obtain the link information from said register of said wired communication unit via the MDIO/MDC, and
said communication control unit is configured to select one of said wired communication unit and said wireless communication unit by electrically connecting the data communication bus with one of said wired communication unit and said wireless communication unit, and electrically disconnecting the data communication bus with the other one of said wired communication unit and said wireless communication unit.

3. The communication device according to claim 2,
wherein said communication control unit is configured to put, in a high impedance state, at least an output terminal of the data communication bus for the unselected one of said wired communication unit and said wireless communication unit, so as to electrically disconnect the data communication bus.

4. The communication device according to claim 3, further comprising
a switch which is provided on the data communication bus and physically connects said communication control unit with only one of said wired communication unit and said wireless communication unit via the data communication bus,
wherein said communication control unit is configured to select one of said wired communication unit and said wireless communication unit by switching said switch.

5. The communication device according to claim 1,
wherein said communication control unit further includes
a counter which counts the number of times said link information detecting unit detects that the wired communication path is electrically linked down, and
said communication control unit is configured to cause said wireless communication unit to communicate with the external device when a value of said counter reaches a predetermined threshold.

6. The communication device according to claim 5,
wherein said communication control unit is configured to reset said counter with one of the following timing: timing with which said wireless communication unit is caused to communicate with the external device; timing with which said link information detecting unit detects that the wired communication path is electrically linked up; and timing with which a predetermined time period elapses after a last detection that the wired communication path is electrically linked down.

7. The communication device according to claim 1,
wherein said communication control unit further includes
a timer which starts with timing when said link information detecting unit detects that the wired communication path is electrically linked down, and
said communication control unit is configured to cause said wireless communication unit to communicate with the external device when said link information detecting unit detects again, at a point in time when said timer expires, that the wired communication path is electrically linked down.

8. The communication device according to claim 1,
wherein said communication control unit is configured to cause said wired communication unit to communicate with the external device when, in a state where said wireless communication unit is selected, said link information detecting unit detects that said wired communication unit is electrically linked up and said wireless communication unit is not communicating with the external device.

9. A television receiver connectable to a network, said television receiver comprising:
said communication device according to claim 1; and
a display unit configured to display content obtained from the external device via said communication device.

10. A reproduction device connectable to a network, said reproduction device comprising:
said communication device according to claim 1; and
a reproducing unit configured to reproduce content obtained from the external device via said communication device.

11. A communication method performed by a communication device to communicate with an external device,
the communication device including:
a wired communication unit configured to communicate with the external device via a wired communication path; and
a wireless communication unit configured to communicate with the external device via a wireless communication path,
said communication method comprising
selecting one of the wired communication unit and the wireless communication unit, and causing the selected communication unit to communicate with the external device,
wherein said selecting includes
detecting link information indicating whether the wired communication path is electrically linked up or linked down, and
in said selecting, the wireless communication unit is selected and caused to communicate with the external device when it is detected a plurality of times in said detecting, in a state where the wired communication unit is selected, that the wired communication path is electrically linked down.

12. A non-transitory computer-readable recording medium for use in a computer, said recording medium having a computer program recorded thereon for causing a communication device to communicate with an external device,
the communication device including:
a wired communication unit configured to communicate with the external device via a wired communication path; and
a wireless communication unit configured to communicate with the external device via a wireless communication path,
the program causing the communication device to execute
selecting one of the wired communication unit and the wireless communication unit, and causing the selected communication unit to communicate with the external device,
wherein the selecting includes
detecting link information indicating whether the wired communication path is electrically linked up or linked down, and
in the selecting, the wireless communication unit is selected and caused to communicate with the external device when it is detected a plurality of times in the detecting, in a state where the wired communication unit is selected, that the wired communication path is electrically linked down.

13. An integrated circuit which communicates with an external device, said integrated circuit comprising:
a wired communication unit configured to communicate with the external device via a wired communication path;
a wireless communication unit configured to communicate with the external device via a wireless communication path; and
a communication control unit configured to select one of said wired communication unit and said wireless communication unit, and to cause said selected communication unit to communicate with the external device,
wherein said communication control unit includes
a link information detecting unit configured to detect link information indicating whether the wired communication path is electrically linked up or linked down, and
said communication control unit is configured to select said wireless communication unit and cause said wireless communication unit to communicate with the external device when, in a state where said wired communication unit is selected, said link information detecting unit detects a plurality of times that the wired communication path is electrically linked down.

14. The communication device according to claim 7,
wherein said communication control unit is configured to set, in said timer, a time until running out of a packet or data accumulated in at least one of a memory and a buffer by said communication device.
